(19) United States
(12) Patent Application Publication
(10) Pub. No.: US 2012/0279041 A1
(43) Pub. Date: Nov. 8, 2012

(54) SIDE STEP BAR MOUNTING SYSTEM FOR TRUCKS

(75) Inventor: Scott Keith Pochurek, Temecula, CA (US)

(73) Assignee: WESTIN AUTOMOTIVE PRODUCTS, Irwindale, CA (US)

(21) Appl. No.: 13/457,587

(22) Filed: Apr. 27, 2012

Related U.S. Application Data
(60) Provisional application No. 61/482,866, filed on May 5, 2011.

(51) Int. Cl. B60R 11/00; B23P 11/00

(52) U.S. Cl. 29/525.01; 248/201

(57) ABSTRACT

The present invention provides a side step bar mounting system comprising at least two mounting assemblies wherein each of the assemblies includes a first bracket, a second bracket, and an isolator assembly comprising a first bushing, a second bushing, a sleeve, at least one isolator washer and a fastener; the first bracket includes a vehicle mounting feature for attaching the first bracket to a vehicle structural member and a fastener feature for attaching to the fastener; the second bracket includes an entry assist member feature for attaching the second bracket to an entry assist member; each of the second bracket, the first bushing and the second bushing includes a sleeve feature for accepting the sleeve; the sleeve includes a channel for allowing the fastener to go through the channel.

### CLAIM OF BENEFIT OF FILING DATE

This application claims the benefit of the filing date of U.S. Provisional Application Ser. No. 61/482,866, titled: “SIDE STEP BAR MOUNTING SYSTEM FOR TRUCKS” filed on May 5, 2011 which is incorporated herein by reference for all purposes.

### FIELD OF INVENTION

The present invention relates to vehicle accessory field. More specifically, it relates to a side step bar mounting system for vehicles, especially trucks.

### BACKGROUND OF INVENTION

Getting in and out of a large vehicle such as a truck, a sport utility vehicle (“SUV”), or a van can be difficult if the vehicle sits high off the ground. Side step bars and running boards installed on driver and/or passenger sides of a vehicle can help the vehicle's driver and passengers get in and out easily and safely.

A truck, such as a light truck or a pickup truck, generally has a passenger carrying portion (“cab”) and open-top rear cargo area (“bed”). The bed is almost always separated from the cab in order to allow for chassis flex when carrying or pulling heavy loads. Conventional side step bars and running boards are generally only installed next to the cab (“cab portion) and do not extend next to the bed (“bed portion”). Accordingly, they generally do not extend from a truck's front wheel(s) to back wheel(s) (“wheel to wheel”) nor do they provide both a cab portion and a bed portion.

Having side step bars and/or running boards with a cab portion and a bed portion is desirable because it provides easy access not only to the cab but also to the bed. Some side step bars have been devised to include a bed portion or even extend from wheel to wheel. Unfortunately, the mounting of such side step bars have, caused problems. For example, some of these side step bars are attached directly to the cab and not to the bed leaving their bed portions dangling and without sufficient structural support. This lack of structural support for the bed portion poses safety concerns for users as they try to step on the bed portion in order to gain better access to the bed.

In an effort to provide more structural support for the bed portion, some side step bars are directly attached with brackets and bolts not only to the cab (usually to the cab's frame) but also to the bed. They are bolted either to the bed's frame or the bed's bottom. Due to the fact that the cab and the bed are separate structures with independent suspension, movements and/or load differentials between the cab and the bed can create stress upon these attachments to the cab and/or the bed (“load differential-stress”) causing undesirable noises and/or even fractures to components of such attachments (e.g., tearing of the truck's bottom at the point of attachment(S) or the like).

### SUMMARY OF THE INVENTION

The present invention solves the above-discussed problems by providing a side step bar mounting system that alleviates the load differential stress which may arise due to the movements and/or load differentials between the cab and the bed and noise that may arise from the installation of a side bar or a running hoard (collectively hereinafter referred to as “entry assist member”) due to the movements of the vehicle while allowing the entry assist member to have both a cab portion and a bed portion (including, without limitations, extending the entry assist member from wheel to wheel), and strong structural support throughout so a user can safely step on the bed portion. The above-described load differential stress and noise shall hereinafter collectively refer to as “differential stress”.

The side step bar mounting system of the present invention includes at least two mounting assemblies wherein each of the at least two mounting assemblies includes a first bracket, a second bracket, and an isolator assembly comprising a first bushing, a second bushing, a sleeve, at least one isolator washer and a fastener; the first bracket includes a vehicle mounting feature for attaching the first bracket to a vehicle structural member and a fastener feature for attaching to the fastener; the second bracket includes an entry assist member feature for attaching the second bracket to an entry assist member; each of the second bracket, the first bushing, the second bushing, and the at least one isolator washer includes a sleeve feature for accepting the sleeve; the sleeve includes a channel for allowing the fastener to go through the channel; the side step bar mounting system when attached to a vehicle and an entry assist member reduces differential stress.

The present invention includes a method of using the above-described side step bar mounting system to mount an entry assist member to vehicle comprising: providing the side step bar mounting system described above comprising a first mounting assembly and a second mounting assembly; assembling each of the first mounting assembly and the second mounting assembly; attaching the first bracket of the first mounting assembly to a first vehicle structural member wherein the first bracket of the first mounting assembly is attached to cab section of the first vehicle structural member; attaching the first bracket of the second mounting assembly to a second vehicle structural member wherein the first bracket of the second mounting assembly is attached to bed section of the second vehicle structural member; attaching the second bracket of the first mounting assembly to the entry assist member in a first location; and attaching the second bracket of the second mounting assembly to the entry assist member in a second location; wherein the sidestep bar mounting system reduces differential stress.

### BRIEF DESCRIPTION OF THE DRAWING

The present invention will be more clearly understood when considering the accompanying drawing of which:

FIG. 1 shows a prospective view of a side step bar mounting system in accordance with the present invention in an assembled configuration;

FIG. 2 shows a prospective exploded view of a mounting assembly shown in FIG. 1;

FIG. 3 shows a prospective exploded view of an isolator assembly shown FIG. 1;

FIG. 4 shows a prospective view of the mounting assembly shown in FIG. 2 in an assembled configuration attached to a side step bar and bottom of a vehicle;

FIG. 5 shows a prospective view of the mounting assembly shown in FIG. 2 in an assembled configuration attached to a running board and bottom of a vehicle;

FIG. 6 shows a prospective view of another embodiment of the mounting assembly in an assembled configuration in accordance with the present invention;

FIG. 7 shows a prospective exploded view of the mounting assembly shown in FIG. 6;

FIG. 8 shows a prospective view of the mounting assembly shown in FIG. 6 in an assembled configuration attached to a side step bar and a frame rail of a vehicle;

FIG. 9 shows a prospective view of the mounting assembly shown in FIG. 6 in an assembled configuration attached to a running board and a frame rail of a vehicle; and

FIG. 10 shows a prospective exploded view of yet another embodiment of the mounting assembly in accordance with the present invention.

### DESCRIPTION OF THE PREFERRED EMBODIMENT

### I. Description of Exemplary Side Step Bar Mounting System

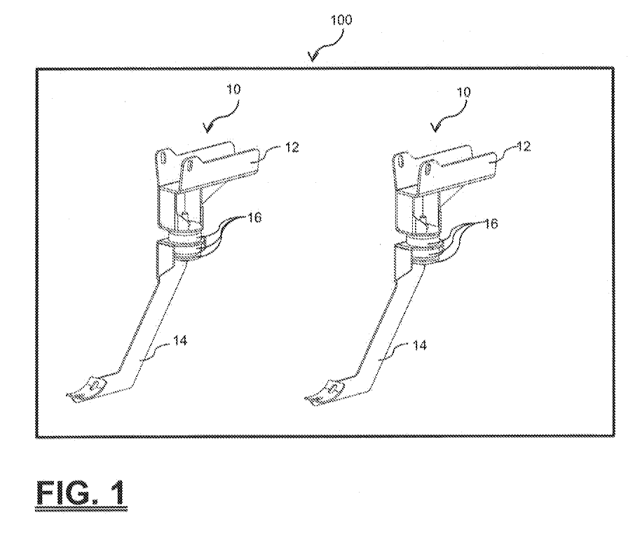

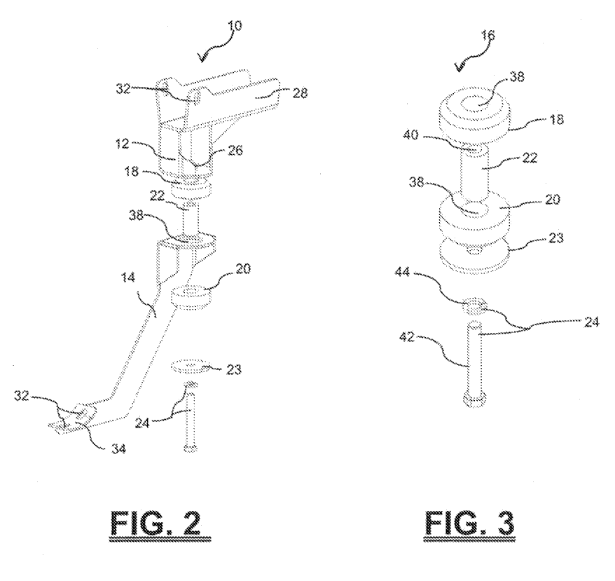

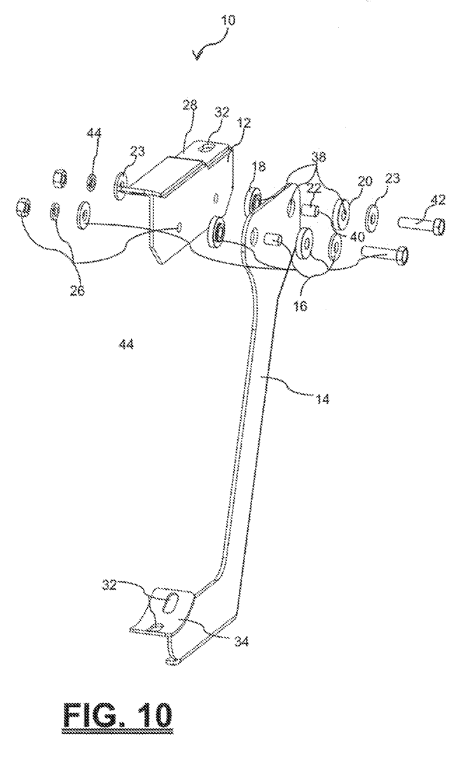

Referring to FIG. 1, the side step bar mounting system 100 of the present invention includes at least two mounting assemblies 10. One exemplary embodiment of the mounting assembly 10 is shown in FIGS. 2-5; another exemplary embodiment of the mounting assembly 10 is shown in FIGS. 3 and 6-9; and yet another exemplary embodiment of the mounting assembly 10 is shown in FIG. 10.

Referring to FIGS. 1-10, each of the at least two mounting assemblies 10 includes a first bracket 12, a second bracket 14, and at least one isolator assembly 16. Referring to FIG. 3, the isolator assembly 16 includes a first bushing 18, a second bushing 20, a sleeve 22, at least one isolator washer 23 and a fastener 24. The purpose of the isolator assembly 16 is to absorb the differential stress.

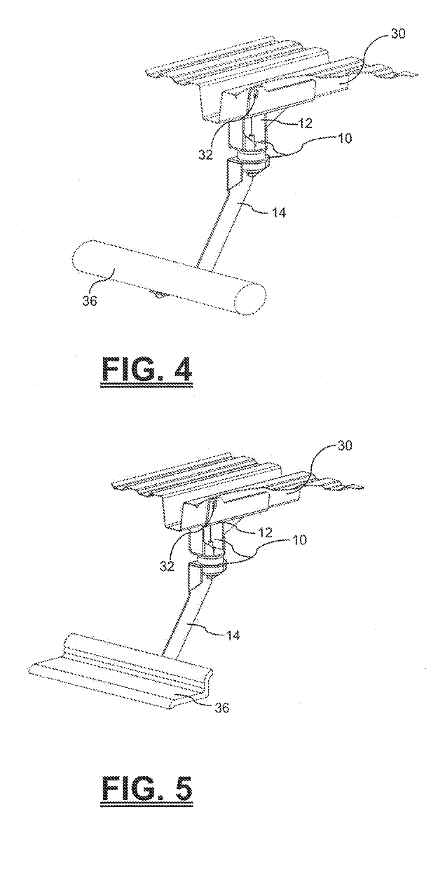

Referring to FIGS. 2, 7 and 10, the first bushing 18 is placed between the first bracket 12 and the second bracket 14. The second bracket is placed between the first bushing 18 and the second bushing 20. These placements can be done vertically as shown in FIGS. 4-9 or horizontally as shown in FIG. 10. Furthermore, additional isolator assembly 16 can be optionally made part of mounting assembly 10. For example, FIG. 10 shows that the mounting assembly 10 has two isolator assemblies 16.

Referring to FIGS. 2, 7 and 10, the first bracket 12 further includes fastener feature 26 for attachment to the fastener 24. The first bracket 12 further includes a vehicle mounting feature 28 for attaching the first bracket 12 to a vehicle structural member 30. The vehicle mounting feature 28 includes bracket aperture(s) 32. The first bracket 12 is attached to the vehicle structural member 30 by aligning the bracket aperture(s) 32 with corresponding aperture(s) (not shown) of the vehicle structural member 30 and then secured, using suitable art-disclosed fastener(s) (not shown).

The first bracket 12 is designed and/or adapted for attachment to the vehicle structural member 30. The vehicle structural, member 30 can be a portion of (i) the vehicle's frame (e.g., a frame rail) or (ii) bottom of a vehicle (“vehicle bottom”). For example, the vehicle bottom in a pickup truck can be bottom of the truck's bed or even bottom of the trucks cab. The configuration or shape (“configuration”) of the first bracket 12 is dependent upon the configuration of the vehicle structural member 30. FIGS. 4-5 show an exemplary embodiment of the mounting assembly 10 wherein the first bracket 12 is attached to the vehicle structural member 30 when the vehicle structural member 30 is a vehicle bottom. FIGS. 8-9 show an exemplary embodiment of the mounting assembly 10 wherein the first bracket 12 is attached to the vehicle structural member 30 when the vehicle structural member 30 is a frame rail of a vehicle.

Referring to FIGS. 2, 4-10, the second bracket 14 includes entry assist member feature 34 for attaching the second bracket 14 to an entry assist member 36. The entry assist member 36 can be any suitable art-disclosed device that provides users with entry assistance into a vehicle such a side step bar as shown in FIGS. 5 and 9), a running board (as shown in FIGS. 4 and 8), or the like. The entry assist member feature 34 includes bracket aperture(s) 32. The second bracket 14 is attached to the vehicle structural member 30 by aligning the bracket aperture(s) 32 with corresponding aperture(s) (not shown) of the entry assist member 36 and then secured using suitable art-disclosed fastener(s) (not shown).

An example of suitable art-disclosed fastener(s) for securing (i) the attachment between the first bracket 12 and the vehicle structural member 30; and (ii) the attachment between the second bracket 14 and the entry assist member 36 are bolts and corresponding nuts and washers (e.g., lock, flat or the like). These bolts, nuts, and washers may be constructed of any suitable size (e.g., M10, M12, M14, M14, M16, ⅛″ ¼″, ½″, ⅜″, 9/16″, etc.) and material. For example, the bolts, nuts and washers are constructed out of tempered steel (e.g., International Organization for Standardization Class 8.8 or 10.9, Society of Automobile Engineers Grade 5 or 8, etc.); or other suitable metal alloy.

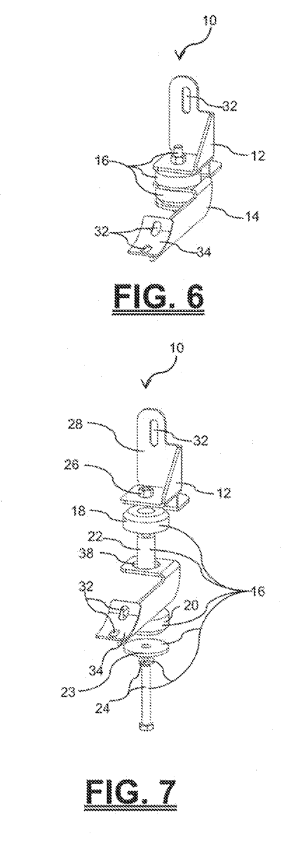

The configuration of the second bracket 14 is dependent upon the location of the vehicle structural member 30 in relation to the desired location of the entry assist member 36. For example, FIGS. 2, 4, 5 and 10 show an exemplary configuration of the second bracket 14 when the vehicle structural member 30 is a vehicle bottom. FIGS. 6-9 show an exemplary configuration of the second bracket 14 when the vehicle structural member 30 is a vehicle frame rail.

Referring to FIGS. 2-3, 7 and 10, the second bracket 14, the first bushing 18 and the second brushing 20 each contains a sleeve feature 38 for accepting the sleeve 22. The sleeve 22 includes a channel 40 for allowing the fastener 24 to go through the channel 40 and be engaged with the fastener feature 26. The purpose of the sleeve 22 is to allow for the isolator assembly 16 to be compressed to a predetermined torque when the fastener 24 is tightened. The sleeve 22 can be constructed of any art-disclosed suitable metal alloy material (e.g., mild steel, stainless steel, or the like.). The sleeve 22 and the channel 40 can be any art-closed suitable shape (e.g., a top view of the sleeve 22 or the channel 40 shows that its shape is round, square, hexagon, or the like). The dimensions of the sleeve 22 and the channel 40 can vary by a large degree as long as they serve their purpose of allowing for the isolator assembly 16 to be compressed to a predetermined torque when the fastener 24 is tightened and engaged with the fastener feature 26. For example, in one embodiment, the length of the sleeve 22 may range from about 10 mm to about 145 mm, from about 24 mm to about 100 mm and from about 48 mm to about 100 mm. The outer diameter of the sleeve 22 may range from about 10 mm to 40 min, from about 20 mm to about 75 mm and from about 25 mm to about 50 mm. Depending upon the size of the fastener 24, the diameter of the channel 40 may provide from about 0.5 mm to about 3 mm or from about 1 mm to about 2 mm clearance around the fastener 24. For example, the diameter of the channel may range from about 12 mm to 36 mm and from about 13 mm to about 20 mm.

The fastener 24 can be any suitable art-disclosed fastener such as bolts and washers constructed out of suitable art-disclosed material (e.g., mild steel, stainless steel, or the like). In one exemplary embodiment and referring to FIGS. 2, 3, 7 and 10 the fastener 24 is hex head bolt 42 and a round lock washer 44. Depending on access, the location of the lock washer 44 can be adjacent to the bolt 42 as shown in FIGS. 2, 3 and 7 or adjacent to the fastener feature 26 as shown in FIG. 10. The shape of the bolt 42 and/or the washer 44 and their overall sizes could vary by a large degree and still function if the other components were similarly adjusted. For example, the bolt 44 may have a diameter ranging from about 10 mm to about 19 mm as long as the dimensions of the other related components of the mounting assembly 10 were also accordingly adjusted.

One of the at least one isolator washers 23 is used to evenly compress at least the second bushing 20 when engaged with the second bushing 20 and the fastener 24. In another exemplary embodiment shown in FIG. 10, an additional isolator washer 23 is included in each of the isolator assemblies 16 placed between the first bracket 12 and the fastener feature 26 to spread the load when the system 100 is assembled and attached to a vehicle. The isolator washer 23 can be constructed of any art-disclosed suitable metal material such as mild steel, stainless steel, or the like. The inner diameter of the isolator washer 23 is dependent upon the size of the bolt 44 of the fastener 24.

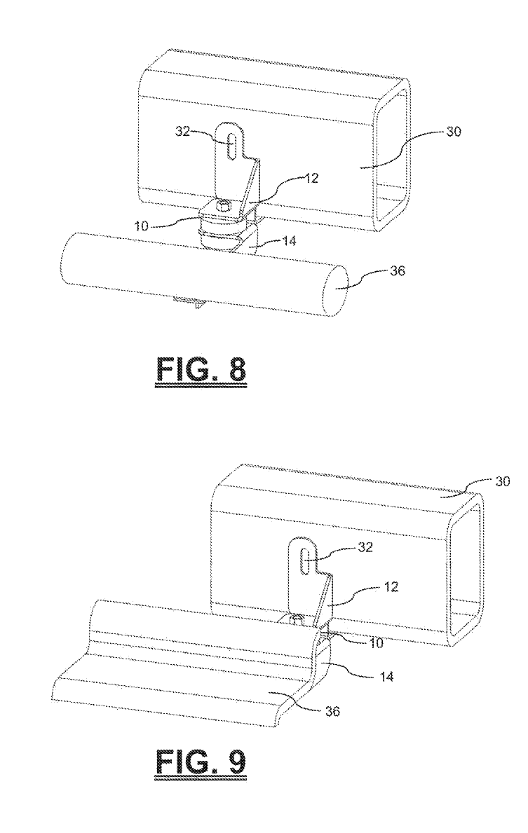

The fastener feature 26 can be any suitable art-disclosed device(s) designed to engage the fastener 24 in order to form a secured attachment. For example and as shown in FIGS. 2 and 7, the fastener feature 26 is comprised of an aperture on a surface of the first bracket 12 (“aperture”) and hex nut placed above the opening in order to allow the fastener 24 to enter through the aperture and engage with the fastener 24 in order to form a secured attachment. The hex nut is welded to the surface of the first bracket 12. Another example of the fastener feature 26 as shown in FIG. 10 is comprised of the aperture and a nut that are not welded together. The shape of the nut and aperture and their overall sizes could vary by a large degree and still function if the other components were similarly adjusted.

The size and shape of the sleeve feature 38 are determined by the size and shape of the sleeve 22. The depth (i.e., thickness) of the sleeve feature 38 is dependent upon the surface thickness or length of the corresponding component where the sleeve feature 38 is located. For example, the depth of the sleeve feature 38 of the first bushing 18 is the length of the first bushing 18. The depth of the sleeve feature 38 of the second hushing 20 is the length of the second hushing. The depth of the sleeve feature 38 of the second bracket 14 is the surface thickness of the portion of the second bracket 14 where the sleeve feature 38 is located.

The number of the isolator assemblies 16 included in the mounting assembly 10 will generally determine the number of sleeve features 38 included in the second bracket and the number of fastener features 26 included in the first bracket as it is preferred that they all have the same ratio. For example and as shown in FIGS. 2 and 4-9, when the mounting assembly 10 includes only one isolator assembly 16, then one sleeve feature 38 is included in the second bracket 14 and one fastener feature 26 is included in the first bracket 12. As shown in FIG. 10, when the mounting assembly 10 includes two isolator assemblies 16, then two (i.e., same ratio) of sleeve features 38 are included in the second bracket 14 and two fastener features 26 are included in the first bracket.

The first bracket 12 and the second bracket 14 can be constructed of any art-disclosed suitable metal alloy material (e.g., mild steel, stainless steel, or the like). The thickness of material can be any suitable art-disclosed thickness. For example, the brackets (12, 14) can be constructed out of mild, steel, having a thickness ranging from about 10 gauge (“ga”) (0.134 inches or 3.404 mm) to about 3 ga (0.239 inches or 6.07 mm), from about 7 ga (0.179 inches or 4.547 mm) to about 4 ga (0.224 inches or 5.69 mm).

The first bushing 18 and the second bushing 20 can be constructed of any art-disclosed suitable isolator materials such as rubber, elastomer (e.g., “synthetic rubber”), plastic, polyurethane, or other polymer. The bushings (18, 20) and the isolator washer 23 can also be any art-closed suitable shape (e.g., round, square, rectangular, hexagon, or the like).
In one exemplary embodiment and referring to FIGS. 2-9, the brackets (12, 14) are constructed out of mild steel with a thickness of 4 ga (0.224 inches or 5.69 mm). The bushings (18, 20) are round cylinders made out of synthetic rubber with a Durometer of 58 (shore hardness). The first bushing has a length of 25.2 mm with an outer diameter of 65 mm. The sleeve feature 38 of the first hushing 18 has a diameter of 25 mm and a depth of 25.2 mm. The second bushing 20 has a length of 23 min with an outer diameter of 65 mm. The sleeve feature 38 of the second bushing 14 has a diameter of 25 mm and a depth of 23 mm. The sleeve feature 38 of the second bracket 14 has a diameter of 25 mm and a depth of 5.69 mm. The sleeve 22 is constructed of stainless steel and is, a round cylinder with an outer diameter of 25 mm and a length of 48 mm. The channel 40 is also a round cylinder with a diameter of 12.5 mm. The fastener 24 includes (i) a class 10.8 hex head bolt with the following dimensions: 12 mm×1.75 mm×80 mm, and (ii) a round lock washer has a length of 3.5 mm with an outer diameter of 19 mm and an inner diameter of 12.5 mm. The isolator washer 23 has a length of 3.5 mm with an outer diameter of 65 mm and an inner diameter of 13 mm.

In another exemplary embodiment and referring to FIG. 10, the brackets (12, 14) are constructed out of mild steel with a thickness of 4 ga (0.224 inches; or 5.69 mm). The bushings (18, 20) are round cylinders made out of synthetic rubber with a Durometer of 58 (shore hardness). The first bushing 18 and the second bushing 20 has a length of 8 mm with an outer diameter of 32 mm. The sleeve feature 38 of these bushings (18, 20) has a diameter of 11 mm and a depth of 16 mm. The sleeve feature 38 of the second bracket 14 has a diameter of 11 mm and a depth of 5.69 mm. The sleeve 22 is constructed of stainless steel and is a round cylinder with an outer diameter of 11 mm and a length of 15 mm. The channel 40 is also a round cylinder with a diameter of 10 mm. The fastener 24 includes (i) a M10 hex head bolt 42 with the following dimensions: 40 mm×1.5 mm, and (ii) a round M10 lock washer 44 that has a length of 2.5 mm with an outer diameter of 30 mm. The fastener feature 26 includes a M10 hex inn having length of 1.50 mm and an aperture feature of the first bracket 12 having a diameter that can accept the bolt 42. Each of the isolator washers 23 is a M10 flat washer having a length of 2.5 mm with an outer diameter of 30 mm.

In other embodiments similar to the embodiment shown in FIG. 10, the first and second bushings (18, 20) may range from about 6 mm to about 12 mm in length with an outer diameter ranging from about 25 mm to about 40 mm. The sleeve feature 38 of the first and second bushings (18, 20) may range from about 10 mm to about 15 mm in diameter and a depth of ranging from about 6 mm to about 1.2 mm. The sleeve feature 38 of the second bracket 14 may have a diameter ranging from about 10 mm to about 15 mm and a depth of about 4 mm to about 6 mm. The sleeve 22 is constructed of stainless steel and is a round cylinder with an outer diameter ranging from about 10 mm to about 15 mm and a length ranging from about 12 mm to about 25 mm. The channel 40 is also a round cylinder with a diameter ranging from about 8 mm to about 1.2 mm. The bolt 42 is sized for acceptance into the channel 40 and the lock washer 44, the fastener feature 26 are sized for proper connection with the bolt 42.

The side step mounting system 100 of the present invention can be used to install the entry assist member 36 onto any vehicle (e.g., cars, trucks, vans, and SUVs) even though its ability to reduce differential stress may be especially applicable for pickup trucks. Accordingly, if the vehicle is not a pickup truck with adistinct cab section and bed section, then the cab section shall be defined as the front driver and front passenger portion of the vehicle and the bed section shall be fined as the portion of the vehicle that is located behind the cab section but before the back wheels of the vehicle.

### II. Description of Exemplary Method of Using the Side Step Bar Mounting System to Mount an Entry Assist Member to a Vehicle

The present invention also provides a method for using the above-described side step bar mounting system 100 to mount an entry assist member (36) to a vehicle. The method includes providing the side step bar mounting system (100) with at least two mounting assemblies (10) (e.g., a first mounting assembly and a second mounting assembly).

The method includes assembling these mounting assemblies (10). To assemble each of the mounting assemblies (10), the first bushing 18 is placed between the first bracket 12 and the second bracket 14, the second bracket 14 is placed between the first bushing 18 and the second bushing 20. The sleeve 22 is inserted into the sleeve features 38 of the second bushing 20, the second bracket 14 and the first bushing 18. The desired portion of the fastener 24 (e.g., bolt 42) is inserted into the isolator washer 23 and then into they channel 40 and engaged with the fastener feature 26 form a secured attachment allowing the isolator assembly 16 to be compressed to a pre-determined torque. For example and shown in FIGS. 2-3 and 7, the fastener 24 includes the bolt 42 and the washer 44. Before the bolt 42 is inserted into the channel 40, the bolt 42 is first inserted into the washer 44 and then into the isolator washer 23 so that when assembled, the washers (44 and 23) are located between one end of the bolt 42 and the second bushing 20. In another embodiment as shown in FIG. 10, the fastener 24 also includes a bolt 42 and a washer 44. Before the bolt 42 is inserted into the channel 40, the bolt 42 is first inserted into a first isolator washer 23 so that when assembled, a first isolator washer 23 is located between one end of the bolt 42 and the second bushing 20. After the belt is inserted in the channel 40, it is then inserted into the aperture of the first bracket 12, a second isolated washer 23, the washer 44, and the hex nut of the fastener feature 26. When assembled, the order the components are: one end of the bolt 42, the first isolator washer 23, the sleeve 22, which has been inserted into the sleeve features 38 of the second bushing 20, the second bracket 14 and the first bushing 12 as shown in FIG. 10, the aperture of the first bracket 12, the second isolator washer 23, the washer 44, and finally the hex nut of the fastener feature 26. For the embodiment in FIG. 10, this assembly step is repeated for each of the two isolator assemblies 16.

The method includes attaching the first bracket (12) of the first mounting assembly (10) to a first vehicle structural member (30), wherein the first bracket (12), of the first mounting assembly (10) is attached to cab section of the first vehicle structural member (30) (i.e. the point of attachment is located; at the cab section of the vehicle). The method also includes attaching the first bracket (12) of the second mounting assembly (10) to a second vehicle structural member (30) wherein the first bracket (12) of the second mounting assembly (10) is attached to bed section of the second vehicle structural member (30) (i.e., the point of attachment is located at the bed section of the vehicle). These attachment steps are done by aligning the bracket aperture(s) (32) of the vehicle mounting feature (28) with corresponding aperture(s) (not shown) of the first or the second vehicle structural member (30) and then secured the attachment using suitable art-disclosed fastener(s) (not shown). It is possible but not required that the first vehicle structural member (30) and the second vehicle structural member (30) are the same component (e.g., same frame rail). Further, the present invention also contemplates that the first structural member (30) is a frame rail while the second vehicle structural member (30) is a vehicle bottom, vice versa, or both members (30) are vehicle bottom.

The method includes attaching the second bracket (14) of the first mounting assembly (10) to the entry assist member (36) in a first location and attaching the second bracket (14) of the second mounting assembly (10) to the entry assist member (36) in a second location. The first location is located next to the cab section of the vehicle and the second location is located next to the bed section of the vehicle. These attachment steps are done by aligning the bracket aperture(s) (32) of the entry assist feature (34) with corresponding aperture(s) (not shown) of the entry assist member (36) and then secured the attachment using suitable art-disclosed fastener(s) (not shown).

It is not required to perform each of various steps for the method in the specific order as described above. In fact, the order of the steps can be changed as desired by the installer. For example, the installer can perform the steps of attaching the first bracket (12) of the first mounting assembly (10) and attaching the first bracket of the second mounting assembly (10) first before assembling each of the mounting assemblies (10), etc. Once the method is completed, the side step bar mounting system (100) of the present invention reduces differential stress.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of unique structures herein and the operation thereof also constitute methods in accordance the present invention.

What is claimed is:

1. A side step bar mounting system comprising at least two mounting assemblies wherein:
a. each of the at least two mounting assemblies includes a first bracket, a second bracket, and an isolator assembly comprising a first bushing, a second bushing, a sleeve, at least one isolator washer and a fastener;
b. the first bracket includes a vehicle mounting feature for attaching the first bracket to a vehicle structural member and a fastener feature for attaching to the fastener;
c. the second bracket includes an entry assist member feature for attaching the second bracket to an entry assist member;
d. each of the second bracket, the first bushing and the second bushing includes a sleeve feature for accepting the sleeve;
e. the sleeve includes a channel for allowing the fastener to go through the channel; and
f. the side step bar mounting system when attached to a vehicle and an entry assist member reduces differential stress.

2. The side step bar mounting system of claim 1 wherein each of the at least two mounting assemblies further comprising an additional isolator assembly.

3. The side step bar mounting system of claim 1 wherein the vehicle structural member is a portion of a frame rail of the vehicle.

4. The side step bar mounting system of claim 1 wherein the vehicle structural member is a portion of bottom of the vehicle.

5. The side step mounting system of claim 1 wherein when the system is assembled and attached to a vehicle, one of the at least one isolator washer is plated between the second bushing and the fastener.

6. The side step mounting system of claim 1 wherein the fastener is comprised of a bolt and corresponding nut and washer and when the system is assembled and attached to a vehicle, one of the at least one isolator washer is placed between the second bushing and the corresponding washer.

7. The side step bar mounting system of claim 1 wherein the fastener is comprised of a hex head bolt and a round lock washer.

8. The side step bar mounting system of claim 7 wherein diameter of the channel provides a clearance ranging from about 0.5 mm to about 3 mm around the hex head bolt.

9. The side step bar mounting system of claim 7 wherein diameter of the hex head bolt ranges from about 10 mm to about 19 mm.

10. The side step bar mounting system of claim 1 wherein each of the first bushing and the second bushings is constructed of synthetic rubber.

11. The side step bar mounting system of claim 1 wherein each of the first bushing and the second bushing has a length ranging from about 6 mm to about 12 mm and an outer diameter ranging from about 25 mm to about 40 mm.

12. The side step bar mounting system of claim 1 wherein the first bracket, the second bracket, the sleeve, the at least one isolator washer and the fastener are constructed of metal or metal alloy.

13. The side step bar mounting system of claim 1 wherein the sleeve has a round cylindrical shape, an outer diameter ranging from about 10 mm to about 15 mm and a length ranging from about 12 mm to about 25 mm.

14. A method of using a side step bar mounting system to mount an entry assist member to a vehicle comprising:
providing a side step bar mounting system comprising a first mounting assembly and a second mounting assembly wherein:
a. each of the first mounting, assembly and the second mounting assembly includes a first bracket, a second bracket, and an isolator assembly comprising a first bushing, a second bushing, a sleeve, at least one isolator washer and a fastener;
b. the first bracket includes a vehicle mounting feature for attaching the firSt bracket to a vehicle structural member and a fastener feature for attaching to the fastener;
c. the second bracket includes an entry assist member feature for attaching the second bracket to an entry assist member;
d. each of the second bracket, the first bushing and the second bushing includes a sleeve feature for accepting the sleeve
e. the sleeve includes a channel for allowing the fastener to go through the channel;
assembling each of the first mounting assembly and the second mounting assembly;
attaching the first bracket of the first mounting assembly to a first vehicle structural member wherein the first bracket of the first mounting assembly is attached to cab section of the first vehicle structural member;
attaching the first bracket of the second mounting assembly to a second vehicle Structural member wherein the first bracket of the second mounting assembly is attached to bed section of the second vehicle structural member;
attaching the second bracket of the first mounting assembly to the entry assist member in a first location; and
attaching the second bracket of the second mounting assembly to the entry assist member in a second location; wherein the side step bar mounting system reduces differential stress.

15. The method of claim 14 wherein when the first bushing is located vertically between the first bracket and the second bracket, and the second bracket is located vertically between the first bushing and the second bushing.

16. The method of claim 14 wherein the first bushing is located horizontally between the first bracket and the second bracket, and the second bracket is located horizontally between the first bushing and the second bushing.

17. The method of claim 14 wherein each of the at least two mounting assemblies further comprising an additional isolator assembly.

18. The method of claim 14 wherein the first vehicle structural member is portion of a frame rail of the vehicle.

19. The method of claim 14 wherein the second vehicle structural member is a portion a frame rail of the vehicle.

20. The method of claim 14 wherein the second vehicle structural member is a portion of bottom of the vehicle.
